(19) United States
(12) Patent Application Publication
(10) Pub. No.: US 2008/0291222 A1
(43) Pub. Date: Nov. 27, 2008

(54) Pulse Generation Circuit and Display Apparatus for Adjusting the Display Brightness of an Image

(75) Inventors: Hung-Lung Hou, Hsinchu (TW); Yi-Pai Huang, Hsinchu (TW); Shang-Chia Liao, Hsinchu (TW); Chang-Han Tsao, Hsinchu (TW); Ting-Jui Chang, Hsinchu (TW); Yao-Jen Hsieh, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/877,923

(22) Filed: Oct. 24, 2007

(30) Foreign Application Priority Data
May 24, 2007 (TW) 96118588

(51) Int. Cl. G09G 5/10; G09G 3/36

(52) U.S. Cl. 345/690; 345/89; 345/92

(57) ABSTRACT

A display apparatus comprises a display panel, a gate driving circuit, and a pulse generation circuit. The display panel displays an image. The gate driving circuit drives the display panel according to a pulse signal generated by the pulse generation circuit. The pulse generation circuit comprises a histogram analysis element and a gate pulse modulator. The histogram analysis element calculates a gray level ratio of the image, and compares the gray level ratio with at least one threshold value to generate at least one control signal. The operative time of the pulse signal is determined in response to the control signal.

This application claims the benefit of priority based on Taiwan Patent Application No. 096118588 filed on May 24, 2006, the disclosures of which are incorporated herein by reference in their entirety.

### BACKGROUND OF THE INVENTION

1. Field of the Invention

The present invention relates to a pulse generation circuit and a display apparatus for adjusting the display brightness of an image; and more particularly, the present invention relates to a pulse generation circuit and a display apparatus for adjusting the display brightness of an image by calculating the distribution of gray levels therein.

2. Descriptions of the Related Art

With the ever increasing use of consumer electronic products, various electronic products have become indispensable in people's life. Display apparatuses are important devices in multimedia electronic products. Among various display apparatuses, the thin film transistor liquid crystal displays (TFT LCDs) have low power consumption, no radiation, small volume, a flat panel profile, high resolution, and stable display quality. As a result, TFT LCDs are widely used in place of conventional cathode ray tube (CRT) displays in many electronic products, such as mobile phones, display screens, digital TVs, and laptops.

As expected, improving the image display quality of the TFT LCDs is important in maintaining its superiority. With respect to the viewing angle range, the technology of the multi-domain vertical alignment (MVA) developed by the FUJITSU Corporation has extended the viewing angle in the vertical direction to about 120°, which represents a substantial improvement of the viewing angle of LCDs and is not inferior to the viewing angle characteristics of CRT displays.

However, at the large viewing angle, LCDs employing the existing MVA technologies, are subjected to color washout and gray level inversions. Color washout, at the large viewing angle, refers to the substantial degradation of the perceived chrominance, and gray level inversion refers to the reverse of the image brightness while the user views at large viewing angles. Such LCDs are undesirable to users.

To solve these two problems found in the aforesaid LCDs employing the existing MVA technologies, some LCD manufacturers have proposed an advanced multi-domain vertical alignment (AMVA) technology to alleviate such problems at large viewing angles. Unfortunately, LCDs employing the AMVA technology cause the degradation of display brightness when working at their maximum brightness (i.e., when the gray level is at the maximum value) due to the design of their interval circuits. The maximum brightness of the LCDs with AMVA technology is lower than that with MVA technology.

Accordingly, there is still a need to find a way for adjusting the brightness of LCDs, so that the aforesaid disadvantages of color washouts and gray level inversions at large viewing angles can be mitigated for an image comprising more medium or low gray levels, while maintaining the brightness of an image comprising more high gray levels.

### SUMMARY OF THE INVENTION

One objective of this invention is to provide a driving circuit for adjusting display brightness of an image, which comprises a histogram analysis element and a gate pulse modulator. The histogram analysis element is configured to calculate a gray level ratio of the image and compare the gray level ratio with a first threshold value. If the gray level ratio is greater than the first threshold value, the histogram analysis element generates a first control signal; otherwise, it generates a second control signal. The gate pulse modulator is configured to generate a pulse signal, while an operative time of the pulse signal is determined in response to either the first or the second control signal. The display brightness of the image is determined in response to the operative time.

Another objective of this invention is to provide a display apparatus for adjusting display brightness of an image, which comprises a pulse generation circuit, a display panel, and a gate driving circuit. The pulse generation circuit is configured to generate a pulse signal according to a gray level ratio of the image. The display panel is configured to display the image. The gate driving circuit is configured to drive the display panel according to the pulse signal. The display brightness of the image is determined in response to an operative time of the pulse signal.

According to this invention, display brightness can be adjusted according to a gray level ratio calculated in an image. The difference between the image perceived at a normal viewing angle and that perceived at a large viewing angle can be mitigated, so that color washout and gray level inversion can be prevented. Moreover, the display brightness is improved effectively when an image with a large ratio of high gray levels is displayed.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating a circuit of embodiments of this invention.

### DESCRIPTION OF THE PREFERRED EMBODIMENT

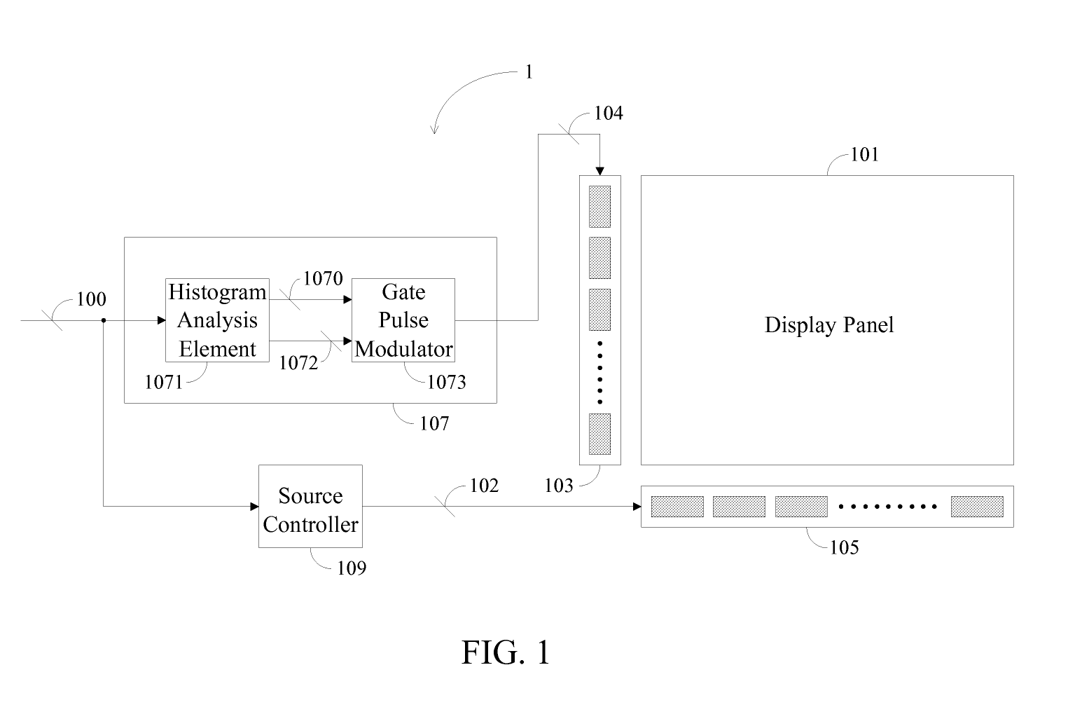

As shown in FIG. 1, a first embodiment of the present invention is a display apparatus 1. The display apparatus 1 comprises a display panel 101, a gate driving circuit 103, a source driving circuit 105, a pulse generation circuit 107, and a source controller 109. To display an image according to a video signal 100, the display panel 101 needs to be driven by the gate driving circuit 103 and the source driving circuit 105. After the video signal 100 is processed to generate a source signal 102 via the source controller 109, the source driving circuit 105 receives the source signal 102 and operates in response thereto. The display panel 101 can be a liquid crystal display (LCD) array or another type of display array.

The gate driving circuit 103 is configured to operate in response to a pulse signal 104 generated by the pulse generation circuit 107. The pulse generation circuit 107 comprises a histogram analysis element 1071 and a gate pulse modulator 1073. The histogram analysis element 1071 is configured to receive the video signal 100 and calculate the gray level ratio of the video signal 100. The gray level ratio of the video signal 100 is obtained in the histogram analysis element 1071 by calculating the number of pixels of each gray level (from level 0 to 255) in an image of the video signal 100 and further calculating a ratio thereof. More specifically, there is a threshold value stored in the histogram analysis element 1071. The threshold value may be preset in the display apparatus 1 before shipment or be set by the user before the display apparatus 1 is used. After obtaining the gray level ratio of the video signal 100 in the way described above, the histogram analysis element 1071 compares the gray level ratio to the threshold value. If the gray level ratio of the image 100 is greater than the threshold value, the histogram analysis element 1071 generates a first control signal 1070. Otherwise, the histogram analysis element 1071 generates a second control signal 1072. Then, the gate pulse modulator 1073 generates a pulse signal 104 according to the first control signal 1070 or the second control signal 1072, wherein the operative time of the pulse signal 104 is determined in response to the control signal received by the gate pulse modulator 1073. More specifically, the operative time of the pulse signal 104 is adjusted as the first operative time when the gate pulse modulator 1073 receives the first control signal 1070, and is adjusted as the second operative time when the gate pulse modulator 1073 receives the second control signal 1072. The first control signal 1070 generated by the histogram analysis element 1071 represents more high gray levels in the video signal 100, so that a longer operative time is required to drive the gate driving circuit 103. Therefore, the first operative time is greater than the second operative time to improve the brightness of the displayed video signal 100.

It can be seen that the display panel 101 has two different display brightness options in response to the aforesaid two different operative times of the pulse signal 104. In this way, the two display modes with different brightness can be used in the display panel 101 to prevent color washout and gray level inversion at large viewing angles.

It should be noted that, although there are two signal lines shown in FIG. 1 to transmit the first control signal 1070 and the second control signal 1072 respectively, this invention does not limit the separation manners of the signals. More specifically, the histogram analysis element 1071 can be designed to represent the presence of more high gray levels and less high gray levels in the video signal 100 respectively with the “high level” signal and the “low level” signal. For example, the signal with the high level represents the first control signal 1070, while the signal with the low level represents the second control signal 1072. In this way, the gray level ratio of the video signal 100 can be transmitted via a single signal line.

A second embodiment of the present invention is also a display apparatus, the structure of which is similar to that of the display apparatus 1 in the first embodiment. The difference between the display apparatus of the first embodiment and the second embodiment is that there are two threshold values stored in the histogram analysis element 1071 of the second embodiment, such as a first threshold value and a second threshold value. In the second embodiment, the first and the second threshold values may be preset in the display apparatus before shipment or be set by the user before the display apparatus is used.

Similarly, after calculating the gray level ratio of the video signal 100, the histogram analysis element 1071 compares the gray level ratio to the first and the second threshold values. If the gray level ratio of the video signal 100 is greater than the first threshold value, the histogram analysis element 1071 generates a first control signal. If the gray level ratio is not greater than the first threshold value but greater than the second threshold value, the histogram analysis element 1071 generates a second control signal. Further, if the gray level ratio is not greater than the second threshold value, the histogram analysis element 1071 generates a third control signal. The gate pulse modulator 1073 then generates the pulse signal 104 in response to these control signals, wherein the operative time of the pulse signal 104 varies with the different control signals.

More specifically, the operative time of the pulse signal 104 is the first operative time when the gate pulse modulator 1073 receives the first control signal, the operative time is the second operative time when the gate pulse modulator 1073 receives the second control signal, and the operative time is the third operative time when the gate pulse modulator 1073 receives the third control signal.

The first control signal generated by the histogram analysis element 1071 represents more data of high gray levels in the video signal 100, so that a longer operative time is required to drive the gate driving circuit 103 in an attempt to improve the image brightness in the displayed video signal 100. The third control signal generated by the histogram analysis element 1071 represents more data of low gray levels in the video signal 100, so that a shorter operative time is required to drive the gate driving circuit 103 in an attempt to prevent color washout and gray level inversion at large viewing angles. The second control signal generated by the histogram analysis element 1071 represents that gray levels of data in the video signal 100 have an average distribution, so that the gate pulse modulator 1073 provides the pulse signal 104 of a predetermined second operative time for the pulse generation circuit 107 to drive the gate driving circuit 103. Hence, the first operative time is greater than the second operative time, and the second operative time is greater than the third operative time.

It can be seen that the display panel 101 has three different display brightness options in response to the aforesaid three operative times of the pulse signal 104. As a result, three display modes with different brightness can be used in the display panel 101 to prevent color washout and gray level inversion at large viewing angles. The display brightness corresponding to different gray level ratios can then be adjusted more finely in the display panel 101.

In the second embodiment, a two-bit digital signal can be used to represent the first, the second, and the third control signals. An example of different comparison results between the gray level ratio and the first and the second threshold values, as well as the two-bit digital signal generated by the histogram analysis element is shown in the table below:

TABLE 1

| | The two- | Output of |
|---|---|---|
| Comparison results in the histogram | bit digital | the histogram |
| analysis element | signal | analysis element |
| The gray level ratio is greater than the | [0, 0] | The first control |
| first threshold value | | signal |
| The gray level ratio is not greater than | [0, 1] | The second |
| the first threshold value but greater | | control signal |
| than the second threshold value | | |
| The gray level ratio is not greater than | [1, 0] | The third control |
| the second threshold value | | signal |

When the gray level ratio is greater than the first threshold value, the two-bit digital signal is [0, 0], and the first control signal is outputted. When the gray level ratio is not greater than the first threshold value but greater than the second threshold value, the two-bit digital signal becomes [0, 1], and the second control signal is outputted. Furthermore, when the gray level ratio is not greater than the second threshold value, the two-bit digital signal becomes [1, 0], and the third control signal is outputted. This invention is not limited the separation manners of the signals.

Accordingly, the display apparatus of the present invention can calculate the gray level ratio of an image and compare the gray level ratio to an inbuilt threshold value to adjust the display brightness according to the comparison result. In this way, the present invention can not only prevent color washouts and gray level inversions at large viewing angles, but also improve the display brightness when an image with a large ratio of high gray levels is displayed, so that a desirable technical breakthrough is achieved, and the display can have a better overall image quality.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A pulse generation circuit for adjusting display brightness of an image, comprising:
a histogram analysis element for calculating a gray level ratio of the image and comparing the gray level ratio with a first threshold value, in which the histogram analysis element generates a first control signal when the gray level ratio is greater than the first threshold value, and the histogram analysis element generates a second control signal when the gray level ratio is not greater than the first threshold value; and
a gate pulse modulator for generating a pulse signal, an operative time of the pulse signal being determined in response to one of the first control signal and the second control signal;
wherein the display brightness of the image is determined in response to the operative time.

2. The pulse generation circuit as claimed in claim 1, wherein the operative time is a first operative time in response to the first control signal, and is a second operative time in response to the second control signal, the first operative time is greater than the second operative time.

3. The pulse generation circuit as claimed in claim 1, wherein the histogram analysis element compares the gray level ratio with a second threshold value, in which the histogram analysis element generates the second control signal when the gray level ratio is not greater than the first threshold value but is greater than the second threshold value, and the histogram analysis element generates a third control signal when the gray level ratio is not greater than the second threshold value, the operative time of the pulse signal is determined in response to one of the first control signal, the second control signal, and the third control signal.

4. The pulse generation circuit as claimed in claim 3, wherein the operative time is a first operative time in response to the first control signal, a second operative time in response to the second control signal, or a third operative time in response to the third control signal, the first operative time is greater than the second operative time, the second operative time is greater than the third operative time.

5. The pulse generation circuit as claimed in claim 4, wherein the second operative time is a predetermined operative time of the pulse generation circuit.

6. A display apparatus for adjusting display brightness of an image, comprising:
a pulse generation circuit for generating a pulse signal according to a gray level ratio of the image;
a display panel for displaying the image; and
a gate driving circuit for driving the display panel according to the pulse signal;
wherein the display brightness of the image is determined in response to an operative time of the pulse signal.

7. The display apparatus as claimed in claim 6, the pulse generation circuit further comprising:
a histogram analysis element for calculating the gray level ratio of the image and comparing the gray level ratio with a first threshold value, in which the histogram analysis element generates a first control signal when the gray level ratio is greater than the first threshold value, and the histogram analysis element generates a second control signal when the gray level ratio is not greater than the first threshold value; and
a gate pulse modulator for generating the pulse signal, the operative time of the pulse signal being determined in response to one of the first control signal and the second control signal.

8. The display apparatus as claimed in claim 7, wherein the operative time is a first operative time in response to the first control signal, and is a second operative time in response to the second control signal, the first operative time is greater than the second operative time.

9. The display apparatus as claimed in claim 7, wherein the histogram analysis element compares the gray level ratio with a second threshold value, in which the histogram analysis element generates the second control signal when the gray level ratio is not greater than the first threshold value but is greater than the second threshold value, and the histogram analysis element generates a third control signal when the gray level ratio is not greater than the second threshold value, the operative time of the pulse signal is determined in response to one of the first control signal, the second control signal, and the third control signal.

10. The display apparatus as claimed in claim 9, wherein the operative time is a first operative time in response to the first control signal, a second operative time in response to the second control signal, or a third operative time in response to the third control signal, the first operative time is greater than the second operative time, the second operative time is greater than the third operative time.

11. The display apparatus as claimed in claim 10, wherein the second operative time is a predetermined operative time of the pulse generation circuit.

12. The display apparatus as claimed in claim 6, wherein the display panel is a liquid crystal display (LCD) array.
